(19) United States
(12) Patent Application Publication
(10) Pub. No.: US 2022/0260143 A1
(43) Pub. Date: Aug. 18, 2022

(54) ROTARY DEVICE AND POWER TRANSMISSION DEVICE

(71) Applicant: EXEDY Corporation, Osaka (JP)

(72) Inventor: Yusuke TOMITA, Osaka (JP)

(21) Appl. No.: 17/576,403

(22) Filed: Jan. 14, 2022

(30) Foreign Application Priority Data
Feb. 15, 2021 (JP) 2021-021568

(51) Int. Cl. F16H 45/02; F16F 15/14

(52) U.S. Cl. CPC F16H 45/02; F16F 15/145; F16F 2232/02; F16H 2045/0263; F16F 2222/08; F16H 2045/0231; F16F 2236/08

(57) ABSTRACT

A rotary device includes a first rotor and a second rotor. The first rotor is disposed to be rotatable. The second rotor is disposed to be rotatable with the first rotor and be rotatable relative to the first rotor. The second rotor includes first and second plates. The first and second plates are configured to form an accommodation space accommodating an outer peripheral portion of the first rotor.

### CROSS-REFERENCE TO RELATED APPLICATIONS

This application claims priority to Japanese Patent Application No. 2021-021568 filed Feb. 15, 2021. The entire contents of that application are incorporated by reference herein in their entirety.

### TECHNICAL FIELD

The present invention relates to a rotary device and a power transmission device.

### BACKGROUND ART

There has been known a type of rotary device including first and second rotors rotatable relative to each other. The first rotor is provided with, for instance, a functional member (a centrifugal element, a pendulum, etc.) attached to an outer peripheral portion thereof so as to exert a function of the rotary device. This type of rotary device is exemplified by a torque fluctuation inhibiting device.

For example, in a torque fluctuation inhibiting device described in Japan Laid-open Patent Application Publication No. 2018-132161, a hub flange and a mass body are rotated relative to each other. The hub flange is provided with a functional member to an outer peripheral portion thereof so as to exert a torque fluctuation inhibiting function. Specifically, the hub flange is provided with a centrifugal element attached to the outer peripheral portion thereof. When the torque fluctuation inhibiting device exerts the torque fluctuation inhibiting function, the centrifugal element is radially moved.

There are concerns in the torque fluctuation inhibiting device described above that, when foreign objects (powder of abraded metal, sand, etc.) are attached to the outer peripheral portion of the hub flange, the functional member such as the centrifugal element is not smoothly actuated, whereby the fiction of the rotary device is hindered.

In view of the above, it is an object of the present invention to inhibit foreign objects from attaching to an outer peripheral portion of a first rotor.

### BRIEF SUMMARY

A rotary device according to a first aspect of the present invention includes a first rotor and a second rotor. The first rotor is disposed to be rotatable. The second rotor is disposed to be rotatable with the first rotor and be rotatable relative to the first rotor. The second rotor includes a first plate and a second plate. The first and second plates are configured to form an accommodation space accommodating an outer peripheral portion of the first rotor.

According to the configuration, the outer peripheral portion of the first rotor is accommodated in the accommodation space formed by the first and second plates. Because of this, foreign objects can be inhibited from attaching to the outer peripheral portion of the first rotor. Besides, when a functional member or so forth attached to the outer peripheral portion of the first rotor is damaged or broken, the damaged or broken member can be prevented from being thrown out by a centrifugal force.

Preferably, the first plate includes a first annular portion and a first cylindrical portion. The first cylindrical portion axially extends from an inner peripheral end of the first annular portion toward the second plate. The second plate includes a second annular portion and a second cylindrical portion. The second annular portion is disposed axially apart from the first annular portion at an interval. The second cylindrical portion axially extends from an outer peripheral end of the second annular portion toward the first plate. According to the configuration, the first and second plates are symmetric in shape. Hence, the second rotor is good in balance. Besides, each of the first and second plates includes the cylindrical portion and is formed by drawing (metalworking). Hence, each of the first and second plates is good in strength.

Preferably, the first annular portion is disposed to produce a first gap between an outer peripheral end thereof and a distal end of the second cylindrical portion. According to the configuration, foreign objects or so forth can be discharged through the first gap when intruding into the accommodation space.

The first plate can include a first annular portion, a first cylindrical portion, and a second cylindrical portion. It should be noted that the first cylindrical portion axially extends from an inner peripheral end of the first annular portion toward the second plate. The second cylindrical portion axially extends from an outer peripheral end of the first annular portion toward the second plate. Besides, the second plate can include a second annular portion disposed axially apart from the first annular portion at an interval.

Preferably, the second annular portion is disposed to produce a second gap between an inner peripheral end thereof and a distal end of the first cylindrical portion.

Preferably, the first rotor includes an inner peripheral portion and a connecting portion. The inner peripheral portion of the first rotor is disposed outside the accommodation space. The connecting portion connects the outer peripheral portion and the inner peripheral portion while passing through the second gap.

Preferably, the connecting portion includes a first support surface facing radially inward. The first cylindrical portion includes a second support surface radially facing the first support surface to be supported by the first support surface. According to the configuration, the second rotor is supported at the second support surface by the first support surface. The first and second support surfaces radially face each other. Because of this, the second rotor is radially positioned with respect to the first rotor. As a result, the second rotor can be inhibited from rotating about an axis eccentric to that of the first rotor.

Preferably, the rotary device further includes a slide member disposed between the first support surface and the second support surface. According to the configuration, the first and second support surfaces can be inhibited from being abraded.

Preferably, the first rotor is made in shape of a plate. Besides, the first rotor is greater in thickness than the second rotor. The slide member is attached to the first support surface. According to the configuration, the slide member is attached to the first rotor that is greater in thickness than the second rotor. Because of this, the configuration is advantageous from the perspective of strength in attaching the slide member to the first support surface by press-fitting or in processing or machining the slide member attached to the first rotor.

Preferably, the rotary device further includes a spacer. The spacer is disposed axially between the first rotor and the second rotor. According to the configuration, the second rotor can be inhibited from tilting to approach the first rotor.

Preferably, the rotary device further includes a centrifugal element disposed to be radially movable. The first rotor includes an accommodation portion accommodating the centrifugal element.

Preferably, the centrifugal element is configured to rotate about a rotational axis thereof in radial movement thereof.

Preferably, the rotary device further includes a first rolling member. The accommodation portion includes a first guide surface and a second guide surface. The first and second guide surfaces circumferentially face each other. The first rolling member is disposed between the first guide surface and the centrifugal element. The first rolling member is configured to roll on the first guide surface in accordance with rotation of the centrifugal element about the rotational axis thereof.

Preferably, the centrifugal element is configured to roll on the second guide surface.

Preferably, the centrifugal element and the first rolling member are each made in shape of a hollow or solid cylinder. A distance between the first guide surface and the second guide surface is less than a sum of a diameter of the centrifugal element and a diameter of the first rolling member.

Preferably, the rotary device further includes a cam mechanism. The cam mechanism receives a centrifugal force acting on the centrifugal element and converts the centrifugal force into a circumferential force directed to reduce rotational phase difference between the first rotor and the second rotor.

Preferably, the cam mechanism includes a cam surface and a cam follower. The cam surface is provided on the centrifugal element. The cam follower makes contact with the cam surface. The cam follower transmits a force therethrough between the centrifugal element and the second rotor.

Preferably, the cam follower rolls on the cam surface.

Preferably, the centrifugal element includes a first through hole axially penetrating therethrough. The cam surface is provided as part of an inner wall surface of the first through hole.

Preferably, the cam follower is attached to the second rotor while being rotatable about a rotational axis thereof.

Preferably, the second rotor includes a second through hole. The cam follower rolls on an inner wall surface of the second through hole.

Preferably, the cam follower is a roller made in shape of a solid or hollow cylinder.

Preferably, the rotary device further includes a cam follower made in shape of a solid or hollow cylinder. The centrifugal element includes a first through hole axially extending. The second rotor includes a second through hole axially extending. The first through hole includes a cam surface provided as part of an inner wall surface thereof. The cam surface faces radially outward and makes contact with the cam follower. The second through hole includes a contact surface provided as part of an inner wall surface thereof. The contact surface faces radially inward and makes contact with the cam follower. The cam surface includes a first region and a second region. The first region makes contact with the cam follower when the centrifugal element rolls on the first guide surface through the first rolling member. The second region makes contact with the cam follower when the centrifugal element rolls on the second guide surface. The first region is different in curved surface shape from the second region.

Preferably, the first region is less in curvature radius than the second region.

Preferably, the contact surface includes a third region and a fourth region. The third region makes contact with the cam follower when the centrifugal element rolls on the first guide surface through the first rolling member. The fourth region makes contact with the cam follower when the centrifugal element rolls on the second guide surface. The third region is different in curved surface shape from the fourth region.

Preferably, the rotary device further includes a cam follower made in shape of a solid or hollow cylinder. The centrifugal element includes a first through hole axially extending. The second rotor includes a second through hole axially extending. The first through hole includes a cam surface provided as part of an inner wall surface thereof. The cam surface faces radially outward and makes contact with the cam follower. The second through hole includes a contact surface provided as part of an inner wall surface thereof. The contact surface faces radially inward and makes contact with the cam follower. The contact surface includes a third region and a fourth region. The third region makes contact with the cam follower when the centrifugal element rolls on the first guide surface through the first rolling member. The fourth region makes contact with the cam follower when the centrifugal element rolls on the second guide surface. The third region is different in curved surface shape from the fourth region.

Preferably, the third region is greater in curvature radius than the fourth region.

Preferably, the rotary device further includes a state maintaining mechanism. The state maintaining mechanism is configured to maintain a state of the centrifugal element such that a boundary between the first region and the second region makes contact with the cam follower when the first rotor and the second rotor are unitarily rotated with each other without being rotated relative to each other.

Preferably, the state maintaining mechanism includes a first engaging portion and a second engaging portion. The first engaging portion is provided on the first rotor. The second engaging portion is provided on the centrifugal element to be engaged with the first engaging portion.

Preferably, the second rotor includes a restriction groove. The first rolling member is supported by the restriction groove.

Preferably, the accommodation portion includes a bottom surface and a connecting surface. The bottom surface faces radially outward. The connecting surface connects the first guide surface and the bottom surface therethrough.

The connecting surface can be made in shape of a curved surface, or alternatively, can be made in shape of a flat surface.

A power transmission device according to a second aspect of the present invention includes an input member, an output member, to which a torque is transmitted from the input member, and the rotary device configured as any of the above.

Overall, according to the present invention, foreign objects can be inhibited from attaching to an outer peripheral portion of a first rotor.

### BRIEF DESCRIPTION OF THE DRAWINGS

FIG. 1 is a schematic diagram of a torque converter.

FIG. 2 is a front view of a torque fluctuation inhibiting device from which a first plate is detached.

FIG. 3 is a cross-sectional view taken along line III in FIG. 2.

FIG. 4 is an enlarged front view of the torque fluctuation inhibiting device.

FIG. 5 is a front view of the torque fluctuation inhibiting device.

FIG. 6 is an enlarged front view of the torque fluctuation inhibiting device.

FIG. 7 is a diagram roughly showing a positional relation among a centrifugal element, a cam follower, an inertia ring, and a first rolling member in a condition without input of torque fluctuations.

FIG. 8 is a diagram roughly showing a positional relation among the centrifugal element, the cam follower, the inertia ring, and the first rolling member in a condition with input of torque fluctuations.

FIG. 9 is a chart showing exemplary characteristics of the torque fluctuation inhibiting device.

FIG. 10 is a schematic diagram of a damper device.

FIG. 11 is an enlarged front view of a torque fluctuation inhibiting device according to a modification.

FIG. 12 is an enlarged front view of another torque fluctuation inhibiting device according to the modification.

FIG. 13 is an enlarged front view of a torque fluctuation inhibiting device according to another modification.

FIG. 14 is an enlarged front view of the torque fluctuation inhibiting device according to another modification described above.

FIG. 15 is an enlarged front view of the torque fluctuation inhibiting device according to another modification described above.

FIG. 16 is an enlarged front view of the torque fluctuation inhibiting device according to another modification described above.

FIG. 17 is an enlarged front view of the torque fluctuation inhibiting device according to another modification described above.

FIG. 18 is an enlarged front view of another torque fluctuation inhibiting device according to another modification described above.

FIG. 19 is an enlarged front view of yet another torque fluctuation inhibiting device according to another modification described above.

FIG. 20 is a cross-sectional view of a torque fluctuation inhibiting device according to yet another modification.

### DETAILED DESCRIPTION

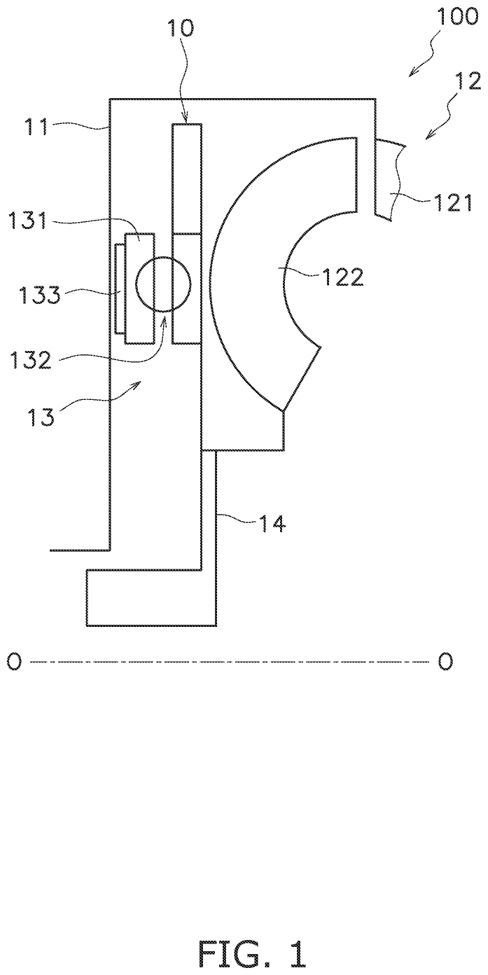

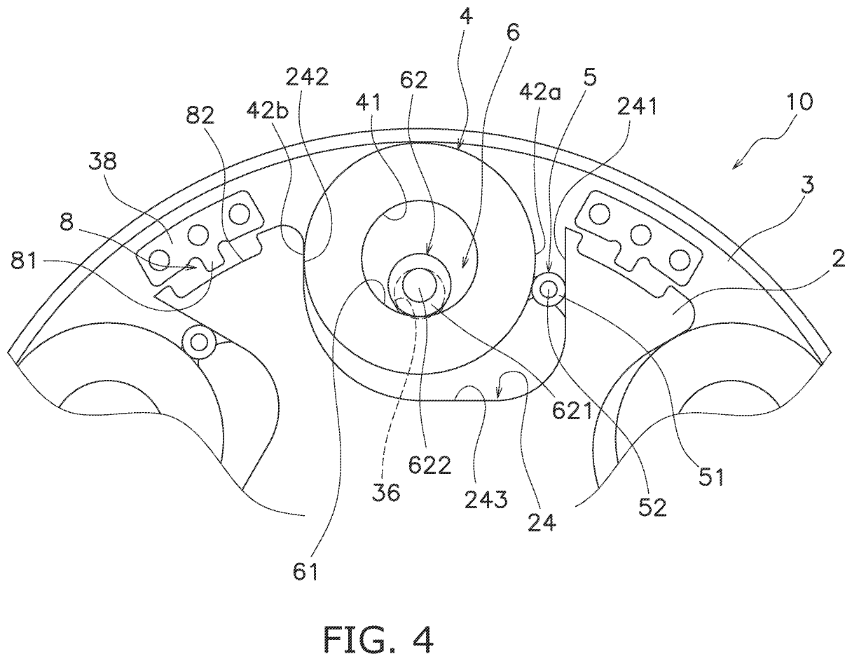

A torque fluctuation inhibiting device (exemplary rotary device) and a torque converter (exemplary power transmission device) according to the present preferred embodiment will be hereinafter explained with reference to drawings. FIG. 1 is a schematic diagram of the torque converter. It should be noted that in the following explanation, the term “axial direction” refers to an extending direction of a rotational axis O of the torque fluctuation inhibiting device. On the other hand, the term “circumferential direction” refers to a circumferential direction of an imaginary circle about the rotational axis O, whereas the term “radial direction” refers to a radial direction of the imaginary circle about the rotational axis O. It should be noted that the circumferential direction is not required to be perfectly matched with that of the imaginary circle about the rotational axis O, and is conceptualized as encompassing, for instance, a right-and-left direction defined based on a centrifugal element in FIG. 4. Likewise, the radial direction is not required to be perfectly matched with a diameter direction of the imaginary circle about the rotational axis O, and is conceptualized as encompassing, for instance, an up-and-down direction defined based on the centrifugal element in FIG. 4.

### [Entire Configuration]

As shown in FIG. 1, a torque converter 100 includes a front cover 11, a torque converter body 12, a lock-up device 13, and an output hub 14 (exemplary output member). The front cover 11 is a member to which a torque is inputted from an engine. The torque converter body 12 includes an impeller 121 coupled to the front cover 11, a turbine 122, and a stator (not shown in the drawings). The turbine 122 is coupled to the output hub 14. An input shaft of a transmission (not shown in the drawings) is spline-coupled to the output hub 14.

### [Lock-Up Device 13]

The lock-up device 13 includes components such as a clutch part and a piston to be actuated by hydraulic pressure or so forth and can be set to a lock-up on state and a lock-up off state. In the lock-up on state, the torque inputted to the front cover 11 is transmitted to the output hub 14 through the lock-up device 13 without through the torque converter body 12. On the other hand, in the lock-up off state, the torque inputted to the front cover 11 is transmitted to the output hub 14 through the torque converter body 12.

The lock-up device 13 includes an input-side rotor 131 (exemplary input member), a damper 132, and a torque fluctuation inhibiting device 10.

The input-side rotor 131 includes a piston movable in the axial direction and a friction member 133 fixed to the front cover 11-side lateral surface thereof. When the friction member 133 is pressed against the front cover 11, the torque is transmitted from the front cover 11 to the input-side rotor 131.

The damper 132 is disposed between the input-side rotor 131 and a hub flange 2 (to be described). The damper 132 includes a plurality of torsion springs and elastically couples the input-side rotor 131 and the hub flange 2 in the circumferential direction. The damper 132 transmits the torque from the input-side rotor 131 to the hub flange 2 therethrough, and besides, absorbs and attenuates torque fluctuations.

### [Torque Fluctuation Inhibiting Device 10]

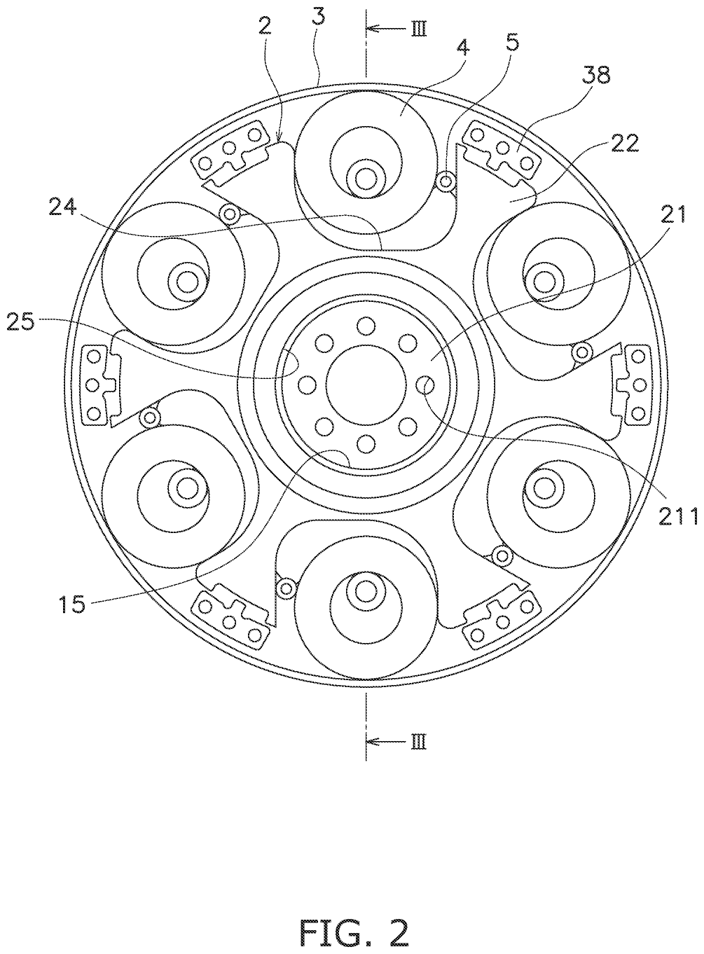

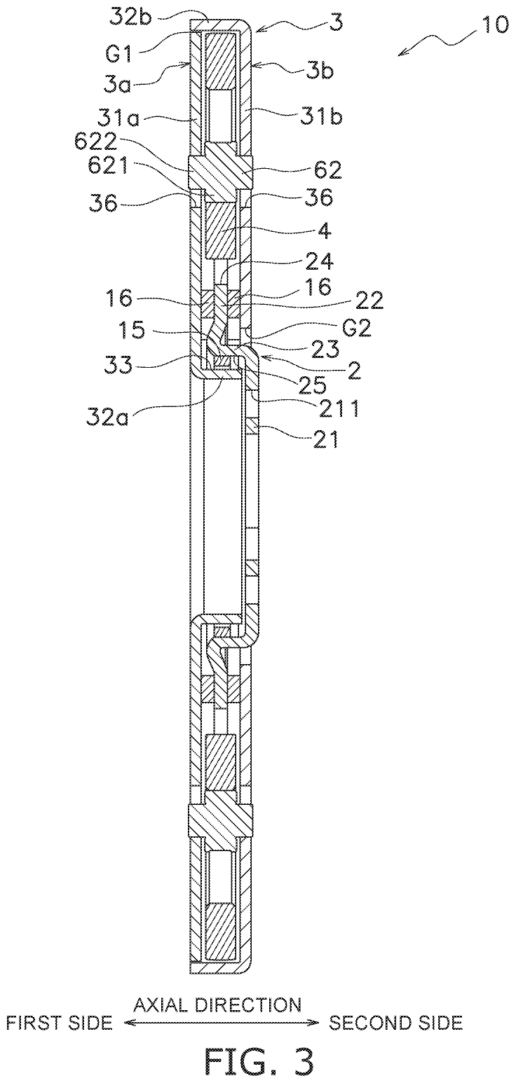

FIG. 2 is a front view of the torque fluctuation inhibiting device 10, whereas FIG. 3 is a cross-sectional view taken along line in FIG. 2. It should be noted that a first plate 3a is detached in FIG. 2.

As shown in FIGS. 2 and 3, the torque fluctuation inhibiting device 10 includes the hub flange 2 (exemplary first rotor), an inertia ring 3 (exemplary second rotor), centrifugal elements 4, first rolling members 5, cam mechanisms 6, a slide member 15, and a pair of spacers 16.

### <Hub Flange 2>

The hub flange 2 is disposed to be rotatable. The hub flange 2 is axially opposed to the input-side rotor 131. The hub flange 2 is rotatable relative to the input-side rotor 131. The hub flange 2 is coupled to the output hub 14. In other words, the hub flange 2 is unitarily rotated with the output hub 14. It should be noted that the hub flange 2 can be integrated with the output hub 14 as a single member.

The hub flange 2 is an annular plate. The hub flange 2 is greater in thickness than each of the first plate 3a and a second plate 3b (both to be described). The hub flange 2 includes an inner peripheral portion 21, an outer peripheral portion 22, and a connecting portion 23. The inner peripheral portion 21 includes a plurality of attachment holes 211. The hub flange 2 is attached at the inner peripheral portion 21 to the output hub 14 by utilizing the attachment holes 211. It should be noted that the inner peripheral portion 21 is disposed outside an accommodation space (to be described).

The outer peripheral portion 22 includes a plurality of accommodation portions 24. In the present preferred embodiment, the outer peripheral portion 22 includes six accommodation portions 24. The plural accommodation portions 24 are disposed apart from each other at intervals in the circumferential direction. Each accommodation portion 24 is opened radially outward. Each accommodation portion 24 has a predetermined depth.

As shown in FIG. 3, the outer peripheral portion 22 is accommodated in the accommodation space (to be described). The outer peripheral portion 22 is different in axial position from the inner peripheral portion 21. When described in detail, the outer peripheral portion 22 is disposed on a first side (left side in FIG. 3) of the inner peripheral portion 21 in the axial direction.

The connecting portion 23 connects the outer peripheral portion 22 and the inner peripheral portion 21 therethrough. When described in detail, the connecting portion 23 connects the outer peripheral end of the inner peripheral portion 21 and the inner peripheral end of the outer peripheral portion 22. The connecting portion 23 extends in the axial direction. The connecting portion 23 has a cylindrical shape.

The hub flange 2 includes a first support surface 25. When described in detail, the connecting portion 23 includes the first support surface 25. The inner peripheral surface of the connecting portion 23 is provided as the first support surface 25. The first support surface 25 faces radially inward. The first support surface 25 has an annular shape. In an axial view, the first support surface 25 has a circular shape.

FIG. 4 is an enlarged view of the torque fluctuation inhibiting device 10. As shown in FIG. 4, each accommodation portion 24 includes a first guide surface 241, a second guide surface 242, and a bottom surface 243. The first guide surface 241, the second guide surface 242, and the bottom surface 243 compose the inner wall surface of each accommodation portion 24.

The first and second guide surfaces 241 and 242 face both sides in the circumferential direction (right-and-left direction in FIG. 4). The first and second guide surfaces 241 and 242 face each centrifugal element 4. Without installation of each centrifugal element 4, the first and second guide surfaces 241 and 242 are opposed to each other. The first and second guide surfaces 241 and 242 extend approximately in parallel to each other. The first and second guide surfaces 241 and 242 are each made in shape of a flat surface.

The bottom surface 243 connects the first guide surface 241 and the second guide surface 242 therethrough. The bottom surface 243 has an approximately circular-arc shape in a front view (axial view). The bottom surface 243 faces radially outward. The bottom surface 243 is opposed to the outer peripheral surface of each centrifugal element 4.

### <Inertia Ring 3>

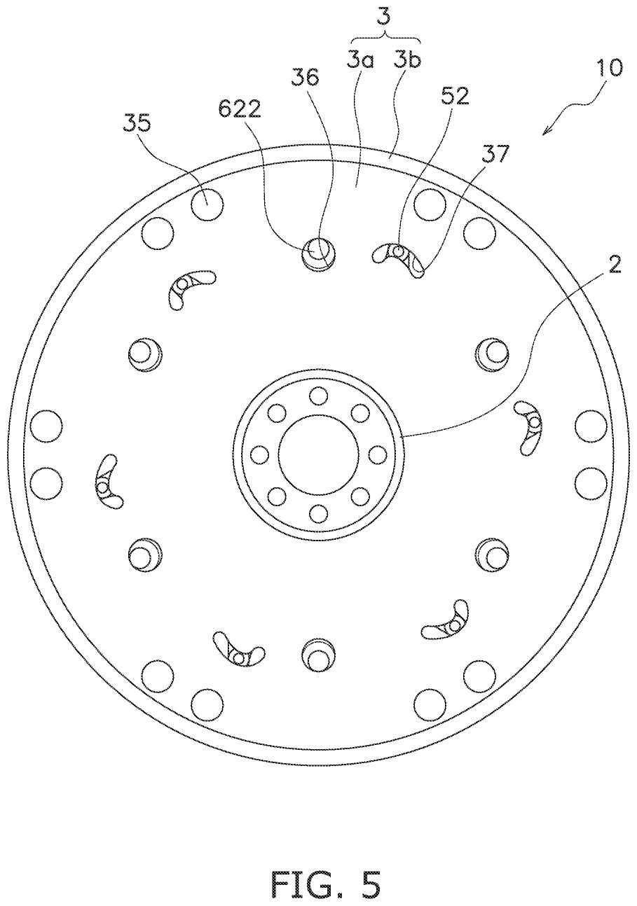

As shown in FIGS. 3 and 5, the inertia ring 3 is made in shape of a continuous annulus. The inertia ring 3 functions as a mass body of the torque fluctuation inhibiting device 10. The inertia ring 3 is rotatable with the hub flange 2 and is also rotatable relative to the hub flange 2. The inertia ring 3 is disposed axially apart from the hub flange 2 at intervals.

The inertia ring 3 is composed of the first and second plates 3a and 3b. The first and second plates 3a and 3b are disposed such that the outer peripheral portion 22 of the hub flange 2 is axially interposed therebetween.

The first and second plates 3a and 3b are disposed axially apart from the outer peripheral portion 22 of the hub flange 2 at predetermined gaps. The inertia ring 3 has a rotational axis common to that of the hub flange 2.

The first and second plates 3a and 3b are fixed to each other by a plurality of rivets 35. Therefore, the first and second plates 3a and 3b are immovable from each other in the axial, radial, and circumferential directions. In other words, the first and second plates 3a and 3b are unitarily rotated with each other.

As shown in FIG. 3, the first plate 3a includes a first annular portion 31a and a first cylindrical portion 32a. The first annular portion 31a has an annular shape. The first annular portion 31a is disposed on the first side of the hub flange 2 in the axial direction. The first annular portion 31a is disposed axially apart from the hub flange 2 at the interval.

The first cylindrical portion 32a extends from the inner peripheral end of the first annular portion 31a toward the second plate 3b in the axial direction. In other words, the first cylindrical portion 32a extends from the inner peripheral end of the first annular portion 31a to a second side in the axial direction.

The first cylindrical portion 32a is disposed radially inside the connecting portion 23. The first cylindrical portion 32a includes a second support surface 33. Specifically, the outer peripheral surface of the first cylindrical portion 32a is provided as the second support surface 33.

The second support surface 33 faces radially outward. The second support surface 33 is configured to be supported by the first support surface 25. When described in detail, the second support surface 33 is configured to be supported by the first support surface 25 through the slide member 15. In the present preferred embodiment, a gap is produced between the second support surface 33 and the slide member 15. When the inertia ring 3 is radially moved, the second support surface 33 makes contact with the slide member 15. It should be noted that the gap may not be produced between the second support surface 33 and the slide member 15.

The second plate 3b includes a second annular portion 31b and a second cylindrical portion 32b. The second annular portion 31b has an annular shape. The second annular portion 31b is disposed on the second side of the hub flange 2 in the axial direction. The second annular portion 31b is disposed axially apart from the hub flange 2 at the interval.

The second annular portion 31b is disposed axially apart from the first annular portion 31a at an interval. The second annular portion 31b is disposed on the second side of the first annular portion 31a in the axial direction. The outer peripheral portion 22 of the hub flange 2 is disposed axially between the first and second annular portions 31a and 31b.

The second cylindrical portion 32b extends from the outer peripheral end of the second annular portion 31b toward the first plate 3a in the axial direction. In other words, the second cylindrical portion 32b extends from the outer peripheral end of the second annular portion 31b to the first side in the axial direction.

The second cylindrical portion 32b is disposed radially outside the outer peripheral portion 22 of the hub flange 2. The inner peripheral surface of the second cylindrical portion 32b is opposed to the outer peripheral surface of the outer peripheral portion 22 of the hub flange 2. The outer peripheral portion 22 of the hub flange 2 is disposed radially between the first and second cylindrical portions 32a and 32b. It should be noted that the outer peripheral portion 22 of the hub flange 2 is disposed axially between the first and second annular portions 31a and 31b. Thus, the first and second plates 3a and 3b form the accommodation space accommodating the outer peripheral portion 22 of the hub flange 2.

A first gap G1 is produced between the outer peripheral end of the first annular portion 31a and the distal end of the second cylindrical portion 32b. In other words, the outer peripheral surface of the first annular portion 31a is disposed apart from the inner peripheral surface of the second cylindrical portion 32b at an interval, while not in contact therewith. The first gap G1 can be provided over the entire range in the circumferential direction, or alternatively, can be provided only in part of the entire range in the circumferential direction. It should be noted that, while the outer peripheral surface of the first annular portion 31a makes contact with the inner peripheral surface of the second cylindrical portion 32b, the first gap G1 may not be produced therebetween.

A second gap G2 is produced between the inner peripheral end of the second annular portion 31b and the distal end of the first cylindrical portion 32a. In other words, the inner peripheral surface of the second annular portion 31b is disposed apart from the outer peripheral surface of the first cylindrical portion 32a at an interval, while not in contact therewith. The second gap G2 is produced over the entire range in the circumferential direction, but alternatively, can be produced only in part of the entire range in the circumferential direction. In the hub flange 2, the connecting portion 23 connects the inner peripheral portion 21 and the outer peripheral portion 22, while extending through the second gap G2.

As shown in FIG. 5, the first plate 3a includes a plurality of second through holes 36. When described in detail, the first annular portion 31a includes the plural second through holes 36. The respective second through holes 36 are aligned in the circumferential direction. The second through holes 36 extend in the axial direction. The second through holes 36 axially penetrate the first annular portion 31a. Each second through hole 36 is greater in diameter than each of a pair of small diameter portions 622 of each cam follower 62 (to be described). Besides, each second through hole 36 is less in diameter than a large diameter portion 621 of each cam follower 62.

The first plate 3a includes a plurality of restriction grooves 37. When described in detail, the first annular portion 31a includes the plural restriction grooves 37. The respective restriction grooves 37 are aligned in the circumferential direction. Each restriction groove 37 is made in shape of a circular arc protruding radially outward.

The second plate 3b includes a plurality of second through holes 36 and a plurality of restriction grooves 37 in similar manner to the first plate 3a. The second through holes 36 provided in the first plate 3a and those provided in the second plate 3b are identical in position to each other in both circumferential and radial directions. Besides, the restriction grooves 37 provided in the first plate 3a and those provided in the second plate 3b are identical in position to each other in both circumferential and radial directions.

As shown in FIG. 2, a plurality of inertia blocks 38 are disposed between the first and second plates 3a and 3b. The plural inertia blocks 38 are disposed apart from each other at intervals in the circumferential direction. For example, the inertia blocks 38 and the centrifugal elements 4 are alternately disposed in the circumferential direction. The inertia blocks 38 are fixed to the first and second plates 3a and 3b. Specifically, the inertia blocks 38 are fixed to the first and second plates 3a and 3b by the rivets 35. It should be noted that each inertia block 38 is greater in thickness than each centrifugal element 4.

### <Slide Member>

As shown in FIGS. 2 and 3, the slide member 15 is disposed between the first and second support surfaces 25 and 33. When described in detail, the slide member 15 is attached to the first support surface 25. The slide member 15 has an annular shape. The slide member 15 is press-fitted to the interior of the connecting portion 23. It should be noted that the hub flange 2 is greater in plate thickness than each first/second plate 3a, 3b.

The slide member 15 is made of a material lower in friction coefficient than that of the hub flange 2. Besides, the material of the slide member 15 is lower in friction coefficient than that of the inertia ring 3. For example, the slide member 15 can be made of resin, more specifically, polytetrafluoroethylene (PTFE), polyether ether ketone (PEEK), thermoplastic polyimide (TPI), or so forth.

The second support surface 33 is configured to be supported by the first support surface 25 through the slide member 15.

The inertia ring 3 has a center of gravity that overlaps not only the first support surface 25 but also the second support surface 33 in a radial view. It should be noted that, as with the present preferred embodiment, when the second support surface 33 is supported by the first support surface 25 through the slide member 15, the center of gravity of the inertia ring 3 overlaps all the first support surface 25, the second support surface 33, and the slide member 15 in the radial view.

### <Spacers>

The pair of spacers 16 is disposed axially between the hub flange 2 and the inertia ring 3. When described in detail, one of the pair of spacers 16 is disposed between the outer peripheral portion 22 and the first plate 3a, whereas the other of the pair of spacers 16 is disposed between the outer peripheral portion 22 and the second plate 3b.

The pair of spacers 16 has an annular shape. The pair of spacers 16 can be fixed to the hub flange 2, or alternatively, can be fixed to the inertia ring 3. The pair of spacers 16 is made of a material lower in friction coefficient than that of the hub flange 2 or that of the inertia ring 3. Specifically, the pair of spacers 16 can be made of resin, more specifically, polytetrafluoroethylene (PTFE), polyether ether ketone (PEEK), thermoplastic polyimide (TPI), or so forth.

### <Centrifugal Elements 4>

Each centrifugal element 4 is disposed within each accommodation portion 24. Each centrifugal element 4 is configured to receive a centrifugal force generated by rotation of the hub flange 2. Each centrifugal element 4 is radially movable within each accommodation portion 24. It should be noted that each centrifugal element 4 is configured to rotate about a rotational axis thereof in radial movement thereof. In the present preferred embodiment, each centrifugal element 4 entirely rotates about the rotational axis thereof. Each centrifugal element 4 is restricted from axially moving by the pair of plates 3a and 3b composing the inertia ring 3.

As shown in FIG. 4, each centrifugal element 4 is made in shape of a disc and includes a first through hole 41 in the middle part thereof. In other words, each centrifugal element 4 is made in shape of a tube or hollow cylinder. Each centrifugal element 4 is greater in thickness than the hub flange 2. Each centrifugal element 4 can be provided as a single member.

Each centrifugal element 4 makes contact with the second guide surface 242 and each first rolling member 5. Because of this, each centrifugal element 4 is restricted from circumferentially moving. On the other hand, each centrifugal element 4 is radially movable. Each centrifugal element 4 rolls on the second guide surface 242 of each accommodation portion 24 in radial movement thereof. Besides, each centrifugal element 4 rolls on the first guide surface 241 through each first rolling member 5 in radial movement thereof. In other words, each centrifugal element 4 rolls on the outer peripheral surface of each first rolling member 5.

When rolling, each centrifugal element 4 rolls in contact at one part of the outer peripheral surface thereof with the outer peripheral surface of each first rolling member 5. This part is defined as a first contact surface 42a. Also, when rolling, each centrifugal element 4 rolls in contact at another part of the outer peripheral surface thereof with the second guide surface 242. This part is defined as a second contact surface 42b. The first and second contact surfaces 42a and 42b each have a circular-arc shape in the axial view.

The first through hole 41 extends in the axial direction. The first through hole 41 penetrates each centrifugal element 4 in the axial direction. The first through hole 41 is greater in diameter than each cam follower 62. When described in detail, the first through hole 41 is greater in diameter than the large diameter portion 621 of each cam follower 62. The inner wall surface of each centrifugal element 4, by which the first through hole 41 is delimited, is provided in part as a cam surface 61.

### <First Rolling Members 5>

Each first rolling member 5 is disposed between the first guide surface 241 and each centrifugal element 4. When described in detail, each first rolling member 5 is interposed between the first guide surface 241 and each centrifugal element 4. Each first rolling member 5 makes contact with the first guide surface 241 and each centrifugal element 4.

The center of each first rolling member 5 is located radially inside that of each centrifugal element 4. Each first rolling member 5 is provided as a roller made in shape of a column or solid cylinder. In other words, each first rolling member 5 is not a bearing.

Each first rolling member 5 includes a large diameter portion 51 and a pair of small diameter portions 52. The center of the large diameter portion 51 is identical in position to that of each small diameter portion 52. The large diameter portion 51 is greater in diameter than each small diameter portion 52. The diameter of the large diameter portion 51 is greater than the width of each restriction groove 37. Because of this, each first rolling member 5 is axially supported by the pair of plates 3a and 3b composing the inertia ring 3.

The pair of small diameter portions 52 protrudes from the large diameter portion 51 to both sides in the axial direction. The diameter of each small diameter portion 52 is less than the width of each restriction groove 37. The pair of small diameter portions 52 is disposed within each pair of restriction grooves 37 of the inertia ring 3. A predetermined gap is produced between each small diameter portion 52 and the inner wall surface of each restriction groove 37, whereby each small diameter portion 52 is smoothly movable within each restriction groove 37. Thus, with the configuration that the pair of small diameter portions 52 is disposed within each pair of restriction grooves 37, each first rolling member 5 can be restricted from radially moving in stop of the torque fluctuation inhibiting device 10. In other words, each first rolling member 5 is supported by each pair of restriction grooves 37.

Each first rolling member 5 can be provided as a single member. In other words, the large diameter portion 51 and the pair of small diameter portions 52 in each first rolling member 5 are provided as a single member. It should be noted that each first rolling member 5 can be made in shape of a column or solid cylinder with a constant diameter. Alternatively, each first rolling member 5 can be made in shape of a tube or hollow cylinder.

Each first rolling member 5 is configured to roll on the first guide surface 241 in accordance with rotation of each centrifugal element 4 about the rotational axis thereof. In other words, when each centrifugal element 4 rotates about the rotational axis thereof, each first rolling member 5 also rotates about a rotational axis thereof. It should be noted that each centrifugal element 4 and each first rolling member 5 rotate in opposite directions. Besides, each first rolling member 5 rolls on the first guide surface 241 by rotating about the rotational axis thereof. When described in detail, the large diameter portion 51 of each first rolling member 5 rolls on the first guide surface 241.

When rotation-directional relative displacement (i.e., rotational phase difference) is not produced between the hub flange 2 and the inertia ring 3, each small diameter portion 52 is located in approximately the lengthwise (i.e., circumferential) middle of each restriction groove 37 as shown in FIG. 5. When the rotational phase difference is then produced between the hub flange 2 and the inertia ring 3, each small diameter portion 52 is moved along each restriction groove 37.

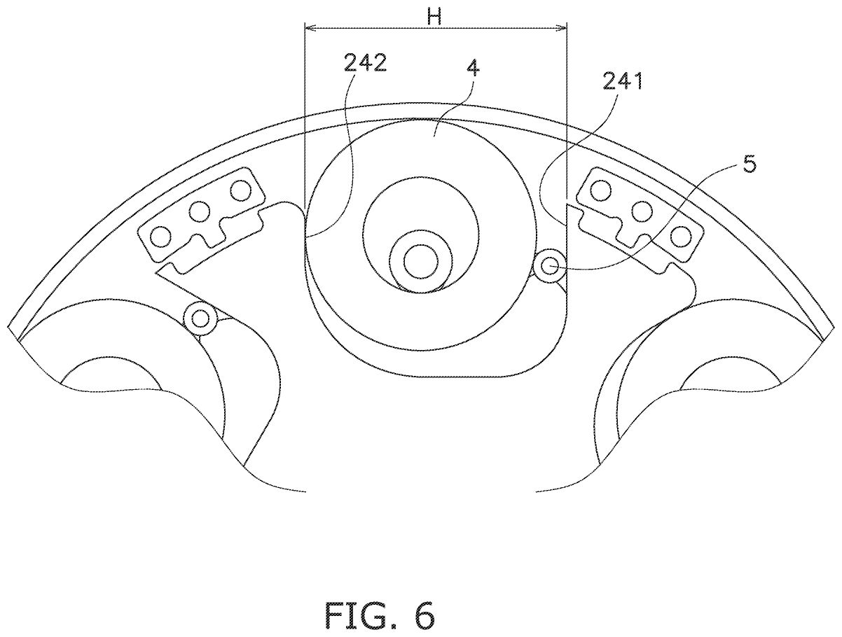

As shown in FIG. 6, a distance (H) between the first guide surface 241 and the second guide surface 242 is less than the sum of the diameter (D1) of each centrifugal element 4 and the diameter (D2) of each first rolling member 5. In other words, the relation “H<D1+D2” is established. Accordingly, during actuation of the torque fluctuation inhibiting device 10, each centrifugal element 4 constantly makes contact with the second guide surface 242 and each first rolling member 5.

The diameter (D2) of each first rolling member 5 is greater than a gap between the first guide surface 241 and the outer peripheral surface of each centrifugal element 4. Hence, each first rolling member 5 is restricted from jumping out radially outward.

### <Cam Mechanisms 6>

As shown in FIG. 4, each cam mechanism 6 is configured to receive a centrifugal force acting on each centrifugal element 4 and convert the centrifugal force into a circumferential force directed to reduce the rotational phase difference between the hub flange 2 and the inertia ring 3. It should be noted that each cam mechanism 6 functions when the rotational phase difference is produced between the hub flange 2 and the inertia ring 3.

Each cam mechanism 6 includes the cam surface 61 and the cam follower 62. The cam surface 61 is provided on each centrifugal element 4. When described in detail, the cam surface 61 is part of the inner wall surface of the first through hole 41 of each centrifugal element 4. The cam surface 61 is a surface, with which the cam follower 62 makes contact, and has a circular-arc shape in the axial view. The cam surface 61 faces radially outward.

The cam follower 62 makes contact with the cam surface 61. The cam follower 62 is configured to transmit a force therethrough between each centrifugal element 4 and the pair of plates 3a and 3b composing the inertia ring 3. When described in detail, the cam follower 62 extends inside both the first through hole 41 and each pair of second through holes 36 of the pair of plates 3a and 3b composing the inertia ring 3. The cam follower 62 is attached to the inertia ring 3, while being rotatable about a rotational axis thereof.

The cam follower 62 rolls on the cam surface 61 of the first through hole 41. Besides, the cam follower 62 rolls on the inner wall surfaces of each pair of second through holes 36 of the pair of plates 3a and 3b. It should be noted that the cam follower 62 makes contact with regions (i.e., regions facing radially inward) of the inner wall surfaces of each pair of second through hole 36 of the pair of plates 3a and 3b. In other words, the cam follower 62 is interposed between the cam surface 61 and the inner wall surfaces of each pair of second through holes 36 of the pair of plates 3a and 3b.

When described in detail, the cam follower 62 makes contact with the cam surface 61 on the radially inner side, while making contact with the inner wall surfaces of each pair of second through holes 36 of the pair of plates 3a and 3b on the radially outer side. This results in positioning of the cam follower 62. Moreover, with the configuration that the cam follower 62 is thus interposed between the cam surface 61 and the inner wall surfaces of each pair of second through holes 36 of the pair of plates 3a and 3b, the cam follower 62 transmits a force therethrough between each centrifugal element 4 and the pair of plates 3a and 3b composing the inertia ring 3.

The cam follower 62 is provided as a roller made in shape of a column or solid cylinder. In other words, the cam follower 62 is not a bearing. The cam follower 62 includes the large diameter portion 621 and the pair of small diameter portions 622. The center of the large diameter portion 621 is identical in position to that of each small diameter portion 622. The large diameter portion 621 is greater in diameter than each small diameter portion 622. The large diameter portion 621 is less in diameter than the first through hole 41 but is greater in diameter than each second through hole 36. The large diameter portion 621 rolls on the cam surface 61.

The pair of small diameter portions 622 protrudes from the large diameter portion 621 to both sides in the axial direction. The pair of small diameter portions 622 rolls on the inner wall surfaces of each pair of second through holes 36 of the pair of plates 3a and 3b. Each small diameter portion 622 is less in diameter than each second through hole 36. The cam follower 62 can be provided as a single member. In other words, the large diameter portion 621 and the pair of small diameter portions 622 in the cam follower 62 are provided as a single member. It should be noted that the cam follower 62 can be made in shape of a column or solid cylinder with a constant diameter. Alternatively, the cam follower 62 can be made in shape of a tube or hollow cylinder.

When the rotational phase difference is produced between the hub flange 2 and the inertia ring 3 by the contact between the cam follower 62 and the cam surface 61 and the contact between the cam follower 62 and the inner wall surfaces of each pair of second through holes 36 of the pair of plates 3a and 3b composing the inertia ring 3, the centrifugal force generated in each centrifugal element 4 is converted into the circumferential force by which the rotational phase difference is reduced.

### <Stopper Mechanisms 8>

The torque fluctuation inhibiting device 10 further includes stopper mechanisms 8. The stopper mechanisms 8 restrict relative rotation between the hub flange 2 and the inertia ring 3 to a predetermined angular range. Each stopper mechanism 8 includes a protrusion 81 and a recess 82.

The protrusion 81 protrudes radially inward from each inertia block 38. The recess 82 is provided on the outer peripheral surface of the hub flange 2. The protrusion 81 is disposed within the recess 82. The relative rotation between the hub flange 2 and the inertia ring 3 is restricted to the predetermined angular range by the contact of the protrusion 81 with each of the end surfaces of the recess 82.

### [Actuation of Torque Fluctuation Inhibiting Device 10]

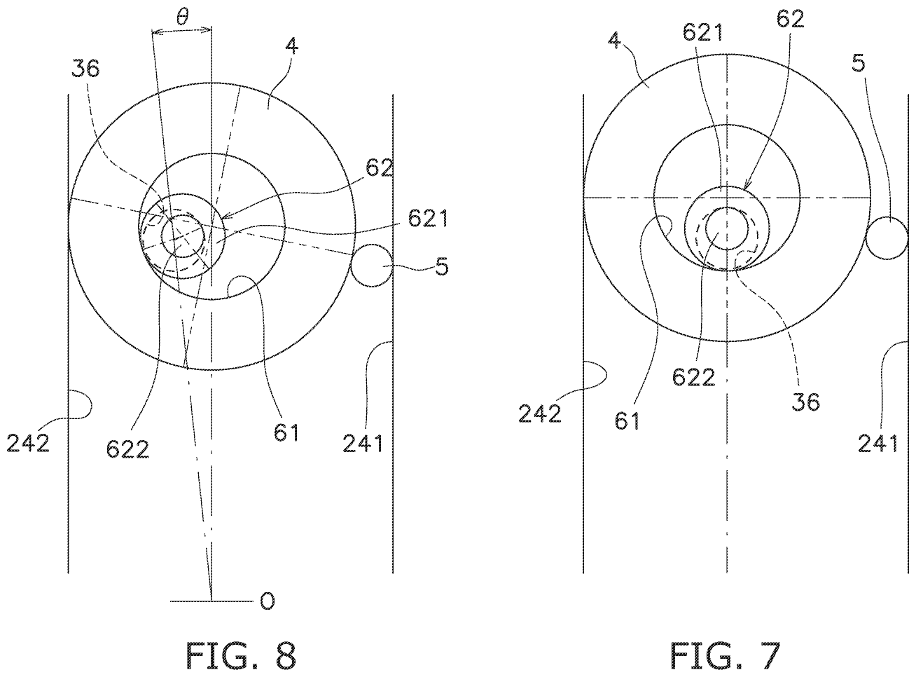

Actuation of the torque fluctuation inhibiting device 10 will be explained with FIGS. 7 and 8.

In the lock-up on state, a torque transmitted to the front cover 11 is transmitted to the hub flange 2 through the input-side rotor 131 and the damper 132.

When torque fluctuations do not exist in torque transmission, the hub flange 2 and the inertia ring 3 are rotated in a condition shown in FIG. 7. In this condition, the cam follower 62 in each cam mechanism 6 makes contact with a radial innermost position (circumferential middle position) of the cam surface 61. Besides, in this condition, the rotational phase difference between the hub flange 2 and the inertia ring 3 is “0”.

As described above, the circumferential relative displacement between the hub flange 2 and the inertia ring 3 is referred to as “rotational phase difference”. In FIGS. 7 and 8, these terms indicate displacement between the circumferential middle position of both each centrifugal element 4 and the cam surface 61 thereof and the center position of each pair of second through holes 36 of the pair of plates 3a and 3b composing the inertia ring 3.

When torque fluctuations herein exist in torque transmission, rotational phase difference θ is produced between the hub flange 2 and the inertia ring 3 as shown in FIG. 8.

As shown in FIG. 8, when the rotational phase difference θ is produced between the hub flange 2 and the inertia ring 3, the cam follower 62 in each cam mechanism 6 is moved from a position shown in FIG. 7 to a position shown in FIG. 8. At this time, the cam follower 62 is relatively moved to the left side, while rolling on the cam surface 61. Besides, the cam follower 62 also rolls on the inner wall surfaces of each pair of second through holes 36 of the pair of plates 3a and 3b composing the inertia ring 3. When described in detail, the large diameter portion 621 of the cam follower 62 rolls on the cam surface 61, whereas the pair of small diameter portions 622 of the cam follower 62 rolls on the inner wall surfaces of each pair of second through holes 36 of the pair of plates 3a and 3b. It should be noted that the cam follower 62 rotates counterclockwise about the rotational axis thereof.

When moved to the left side, the cam follower 62 presses the centrifugal element 4 radially inward (downward in FIGS. 7 and 8) through the cam surface 61, whereby the centrifugal element 4 is moved radially inward. As a result, the centrifugal element 4 is moved from a position shown in FIG. 7 to a position shown in FIG. 8. At this time, the centrifugal element 4 rolls on the second guide surface 242. The centrifugal element 4 rotates clockwise about the rotational axis thereof. It should be noted that the first rolling member 5 rotates counterclockwise about the rotational axis thereof in accordance with clockwise rotation of the centrifugal element 4 about the rotational axis thereof. Then, the first rolling member 5 is moved radially inward, while rolling on the first guide surface 241.

A centrifugal force is acting on the centrifugal element 4 moved to the position shown in FIG. 8 as described above. Hence, the centrifugal element 4 is moved radially outward (upward in FIG. 8). When described in detail, the centrifugal element 4 is moved radially outward, while rolling on the second guide surface 242. It should be noted that the centrifugal element 4 rotates counterclockwise about the rotational axis thereof. Thus, the first rolling member 5 rotates clockwise about the rotational axis thereof in accordance with counterclockwise rotation of the centrifugal element 4 about the rotational axis thereof. Then, the first rolling member 5 is moved radially outward, while rolling on the first guide surface 241.

Besides, the cam surface 61 provided on the centrifugal element 4 presses the inertia ring 3 through the cam follower 62 to the right side in FIG. 8, whereby the inertia ring 3 is moved to the right side in FIG. 8. At this time, the large diameter portion 621 of the cam follower 62 rolls on the cam surface 61, whereas the pair of small diameter portions 622 of the cam follower 62 rolls on the inner wall surfaces of each pair of second through holes 36 of the pair of plates 3a and 3b composing the inertia ring 3. It should be noted that the cam follower 62 rotates clockwise about the rotational axis thereof. As a result, the condition shown in FIG. 7 is restored.

It should be noted that when the rotational phase difference is reversely produced, the cam follower 62 is relatively moved along the cam surface 61 to the right side in FIG. 8. However, the actuation principle described above is also true of this case. At this time, the centrifugal element 4 rolls on the first guide surface 241 through the first rolling member 5.

As described above, when the rotational phase difference is produced between the hub flange 2 and the inertia ring 3 by torque fluctuations, the hub flange 2 receives the circumferential force directed to reduce the rotational phase difference between the both by the centrifugal force acting on each centrifugal element 4 and the working of each cam mechanism 6. Torque fluctuations are inhibited by this force. It should be noted that a force is transmitted between each centrifugal element 4 and the inertia ring 3 through each cam follower 62.

The force described above, by which torque fluctuations are inhibited, varies in accordance with the centrifugal force, in other words, the rotational speed of the hub flange 2 and varies as well in accordance with the rotational phase difference and the shape of the cam surface 61. Therefore, by suitably setting the shape of the cam surface 61, characteristics of the torque fluctuation inhibiting device 10 can be made optimal in accordance with the specification of the engine and so forth.

Besides, each centrifugal element 4 is radially moved, while indirectly or directly rolling on the first or second guide surface 241, 242. Because of this, each centrifugal element 4 is radially movable in smoother manner than that sliding on the first or second guide surface 241, 242. Moreover, each cam follower 62 rolls on the cam surface 61 and the inner wall surfaces of each pair of second through holes 36 of the pair of plates 3a and 3b composing the inertia ring 3. Because of this, a force can be transmitted between each centrifugal element 4 and the inertia ring 3 in as smooth manner as possible.

### [Exemplary Characteristics]

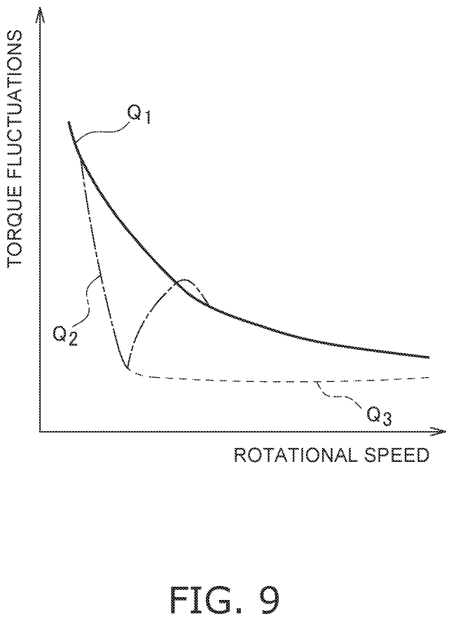

FIG. 9 is a chart showing exemplary characteristics of the torque fluctuation inhibiting device 10. The horizontal axis indicates rotational speed, whereas the vertical axis indicates torque fluctuations (rotational speed fluctuations). Characteristic Q1 indicates a condition without installation of a device for inhibiting torque fluctuations; characteristic Q2 indicates a condition with installation of a well-known dynamic damper device without any cam mechanism; and characteristic Q3 indicates a condition with installation of the torque fluctuation inhibiting device 10 of the present preferred embodiment.

As is obvious from FIG. 9, in an apparatus in which the well-known dynamic damper device without any cam mechanism is installed (characteristic Q2), torque fluctuations can be inhibited only in a specific rotational speed range. By contrast, in the condition with installation of the torque fluctuation inhibiting device 10 with the cam mechanisms 6 of the present preferred embodiment (characteristic Q3), torque fluctuations can be inhibited through the entire rotational speed ranges.

### [Modifications]

The present invention is not limited to the preferred embodiment described above, and a variety of changes or modifications can be made without departing from the scope of the present invention.

### <Modification 1>

In the preferred embodiment described above, the torque fluctuation inhibiting device has been exemplified as the rotary device. However, the rotary device can be any suitable device other than the torque fluctuation inhibiting device, for instance, a clutch device, a damper device, or so forth.

### <Modification 2>

In the preferred embodiment described above, the hub flange 2 has been exemplified as the first rotor. However, the first rotor is not limited to the above. For example, when a torque fluctuation inhibiting device is attached to a torque converter as configured in the present preferred embodiment, the front cover 11, the input-side rotor 131, or so forth can be set as the first rotor in the torque converter 100.

### <Modification 3>

In the preferred embodiment described above, the torque fluctuation inhibiting device 10 is attached to the torque converter 100. Alternatively, the torque fluctuation inhibiting device 10 can be attached to another type of power transmission device such as a clutch device.

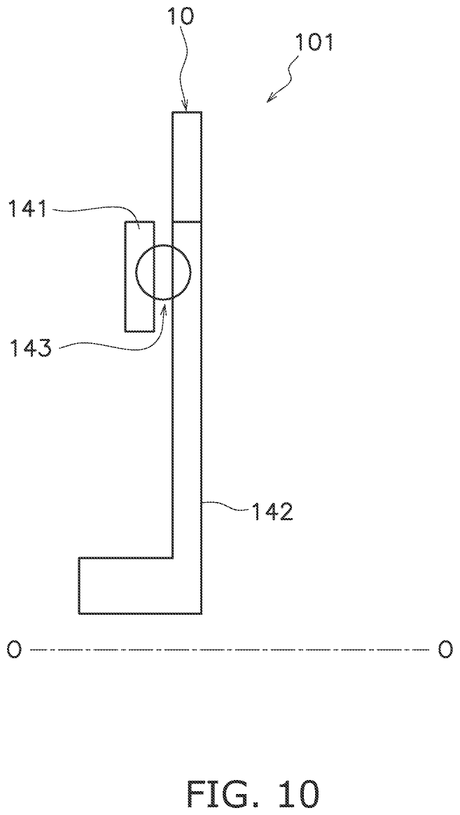

For example, as shown in FIG. 10, the torque fluctuation inhibiting device 10 can be attached to a damper device 101. The damper device 101 is installed in, for instance, a hybrid vehicle. The damper device 101 includes an input member 141, an output member 142, a damper 143, and the torque fluctuation inhibiting device 10. The input member 141 is a member to which a torque is inputted from a drive source. The damper 143 is disposed between the input member 141 and the output member 142. The output member 142 is a member to which the torque is transmitted from the input member 141 through the damper 143. The torque fluctuation inhibiting device 10 is attached to, for instance, the output member 142.

### <Modification 4>

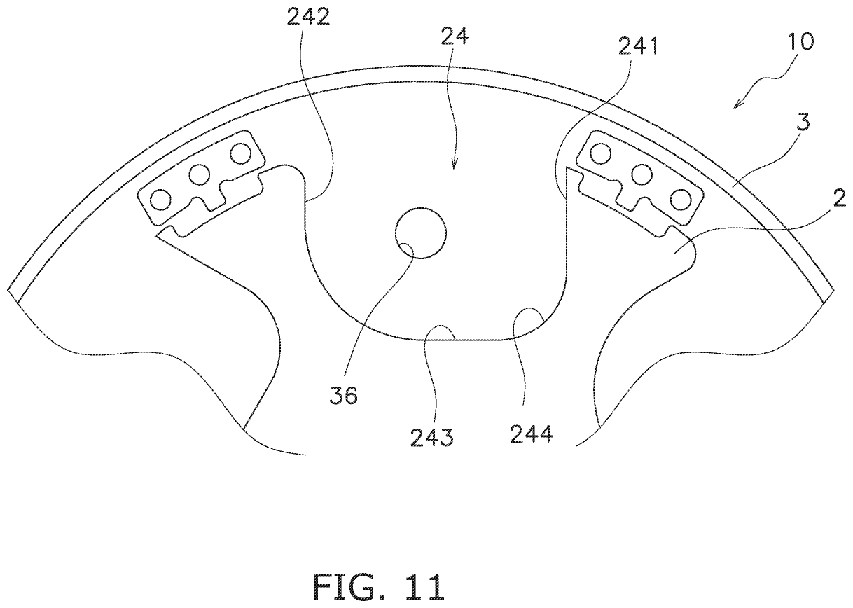

FIG. 11 is an enlarged front view of the torque fluctuation inhibiting device 10 in a condition that one of the pair of plates 3a and 3b composing the inertia ring 3, the centrifugal elements 4, and the first rolling members 5 are detached therefrom. As shown in FIG. 11, each accommodation portion 24 includes the first guide surface 241, the second guide surface 242, the bottom surface 243, and a connecting surface 244.

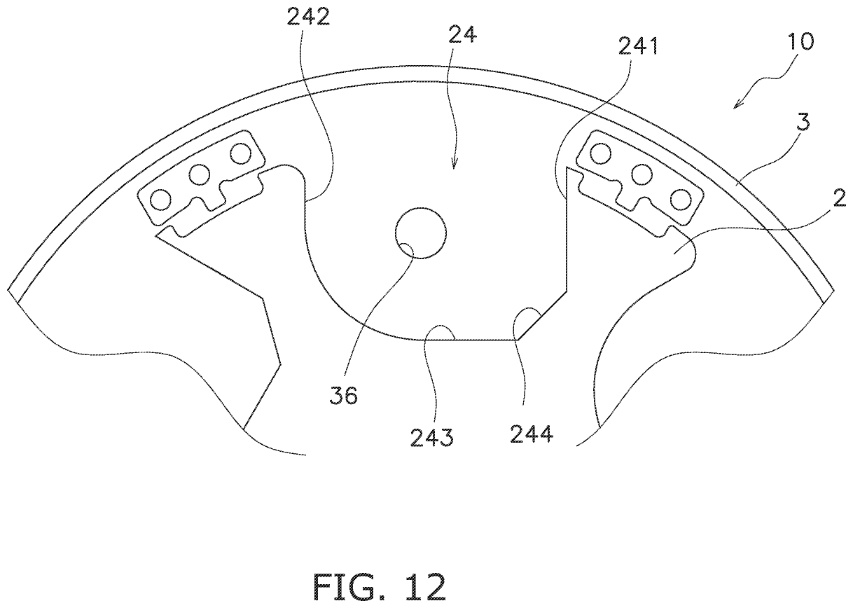

The connecting surface 244 connects the first guide surface 241 and the bottom surface 243 therethrough. The connecting surface 244 faces in both circumferential and radial directions. The connecting surface 244 is made in shape of a curved surface. When described in detail, the connecting surface 244 is made in shape of a recessed curved surface. In the axial view, the connecting surface 244 has a circular-arc shape. Preferably, the connecting surface 244 is set to have a curvature radius greater than or equal to the radius of each first rolling member 5. It should be noted that as shown in FIG. 12, the connecting surface 244 can be made in shape of a flat surface.

The connecting surface 244 is located radially inside each first rolling member 5. Hence, when each first rolling member 5 falls radially inward by the weight thereof, production of falling sound can be inhibited. It should be noted that in the present modification, the inertia ring 3 is not provided with the restriction grooves 37.

### <Modification 5>

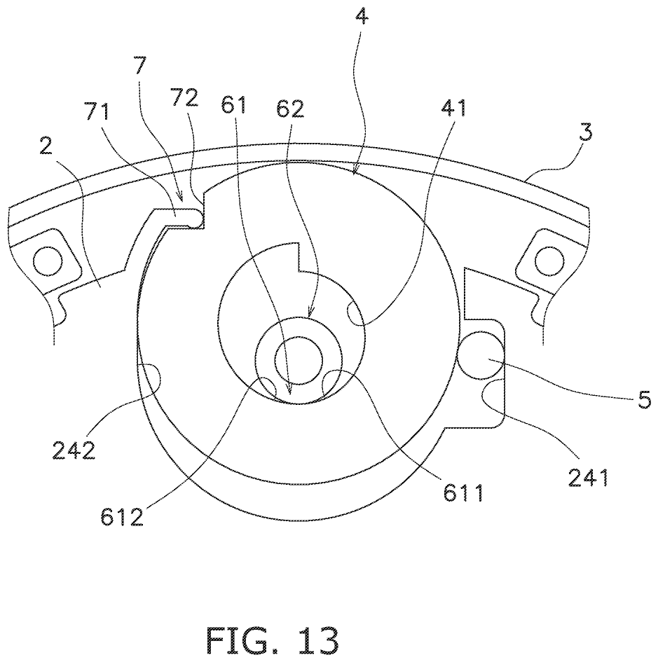

In the preferred embodiment described above, the first through hole 41 of each centrifugal element 4 is made in shape of a true circle in the axial view. However, the shape of the first through hole 41 is not limited to the above. As shown in FIG. 13, for instance, the first through hole 41 of each centrifugal element 4 may not be made in shape of a true circle in the axial view. This configuration will be hereinafter explained in detail.

As shown in FIG. 13, the cam surface 61 is provided as part of the inner wall surface of the first through hole 41. The cam surface 61 faces radially outward. In actuation of the torque fluctuation inhibiting device 10, each centrifugal element 4 is moved radially outward, whereby the cam surface 61 makes contact with each cam follower 62. When described in detail, the cam surface 61 makes contact with the large diameter portion 621 of each cam follower 62.

The cam surface 61 includes a first region 611 and a second region 612. The first region 611 is a region that makes contact with each cam follower 62 when each centrifugal element 4 rolls on the first guide surface 241 through each first rolling member 5. For example, when the inertia ring 3 is rotated clockwise relative to the hub flange 2, the first region 611 makes contact with each cam follower 62. In other words, the first region 611 is a region ranging from the radially innermost part of the cam surface 61 to the first guide surface 241 side (right side in FIG. 13).

The second region 612 is a region that makes contact with each cam follower 62 when each centrifugal element 4 rolls on the second guide surface 242. For example, when the inertia ring 3 is rotated counterclockwise relative to the hub flange 2, the second region 612 makes contact with each cam follower 62. In other words, the second region 612 is a region ranging from the radially innermost part of the cam surface 61 to the second guide surface 242 side (left side in FIG. 13).

The first region 611 is different in curved surface shape from the second region 612. Each of the first and second regions 611 and 612 has a circular-arc shape in the axial view. In the present modification, the first region 611 is less in curvature radius than the second region 612.

It should be noted that in the present modification, as seen in the axial direction, the right half of the first through hole 41 has a semicircular shape; likewise, the left half of the first through hole 41 has a semicircular shape. In the axial view, the semicircle forming the right half of the first through hole 41 is less in radius than that forming the left half of the first through hole 41. In other words, the first through hole 41 is composed of two semicircles different in radius from each other in the axial view.

A boundary between the first and second regions 611 and 612 is the radially innermost part of the cam surface 61. The boundary between the first and second regions 611 and 612 makes contact with each cam follower 62 when the hub flange 2 and the inertia ring 3 are unitarily rotated without being rotated relative to each other, i.e., when the rotational phase difference θ between the hub flange 2 and the inertia ring 3 is zero.

It should be noted that when the boundary between the first and second regions 611 and 612 makes contact with each cam follower 62 as described above, each centrifugal element 4 is in a state referred to as “neutral state”. Conversely, when each centrifugal element 4 is in the neutral state, the boundary between the first and second regions 611 and 612 makes contact with each cam follower 62.

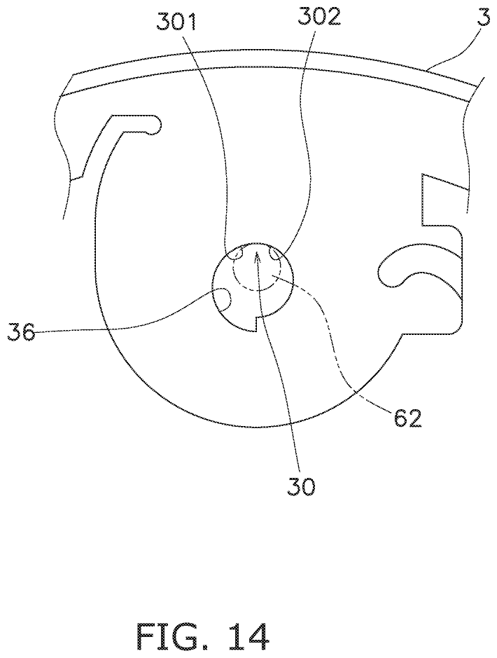

FIG. 14 is a front view of the torque fluctuation inhibiting device in a condition that each centrifugal element 4, each first rolling member 5, and each cam follower 62 are detached therefrom. As shown in FIG. 14, each second through hole 36 can be made in a shape other than a true circle in the axial view.

A contact surface 30 is provided as part of the inner wall surface of each second through hole 36. The contact surface 30 faces radially inward. The contact surface 30 makes contact with each cam follower 62. It should be noted that the contact surface 30 makes contact with each cam follower 62 in actuation and stop of the torque fluctuation inhibiting device 10. When described in detail, the contact surface 30 makes contact with each small diameter portion 622 of each cam follower 62.

The contact surface 30 includes a third region 301 and a fourth region 302. The third region 301 is a region that makes contact with each cam follower 62 when each centrifugal element 4 rolls on the first guide surface 241 through each first rolling member 5. For example, when the inertia ring 3 is rotated clockwise relative to the hub flange 2, the third region 301 makes contact with each cam follower 62. In other words, the third region 301 is a region ranging from a radially outermost part of the contact surface 30 to the second guide surface 242 side (left side in FIG. 14).

The fourth region 302 is a region that makes contact with each cam follower 62 when each centrifugal element 4 rolls on the second guide surface 242. For example, when the inertia ring 3 is rotated counterclockwise relative to the hub flange 2, the fourth region 302 makes contact with each cam follower 62. In other words, the fourth region 302 is a region ranging from the radially outermost part of the contact surface 30 to the first guide surface 241 side (right side in FIG. 14).

The third region 301 is different in curved surface shape from the fourth region 302. Each of the third and fourth regions 301 and 302 has a circular-arc shape in the axial view. In the present modification, the third region 301 is greater in curvature radius than the fourth region 302.

It should be noted that in the present modification, as seen in the axial direction, the right half of each second through hole 36 has a semicircular shape; likewise, the left half of each second through hole 36 has a semicircular shape. In the axial view, the semicircle forming the right half of each second through hole 36 is less in radius than that forming the left half of each second through hole 36. In other words, each second through hole 36 is composed of two semicircles different in radius from each other in the axial view.

A boundary between the third and fourth regions 301 and 302 is the radially outermost part of the contact surface 30. When each centrifugal element 4 is in the neutral state, each cam follower 62 makes contact with the boundary between the third and fourth regions 301 and 302.

As shown in FIG. 13, the torque fluctuation inhibiting device 10 includes state maintaining mechanisms 7. When the hub flange 2 and the inertia ring 3 are unitarily rotated, i.e., when the rotational phase difference θ is zero, each state maintaining mechanism 7 is configured to maintain the neutral state of each centrifugal element 4. Because of this, when the rotational phase difference θ is zero, the boundary between the first and second regions 611 and 612 makes contact with each cam follower 62.

Each state maintaining mechanism 7 includes a first engaging portion 71 and a second engaging portion 72. The first engaging portion 71 is provided on the hub flange 2. The first engaging portion 71 protrudes from the hub flange 2 toward each centrifugal element 4.

The second engaging portion 72 is provided on each centrifugal element 4. The second engaging portion 72 is a recess provided on each centrifugal element 4. The second engaging portion 72 is engaged with the first engaging portion 71. When described in detail, the first engaging portion 71 is disposed within the second engaging portion 72. Because of this, the first and second engaging portions 71 and 72 make contact with each other. As a result, when the hub flange 2 and the inertia ring 3 are not rotated relative to each other, each centrifugal element 4 is restricted from rotating about the rotational axis thereof.

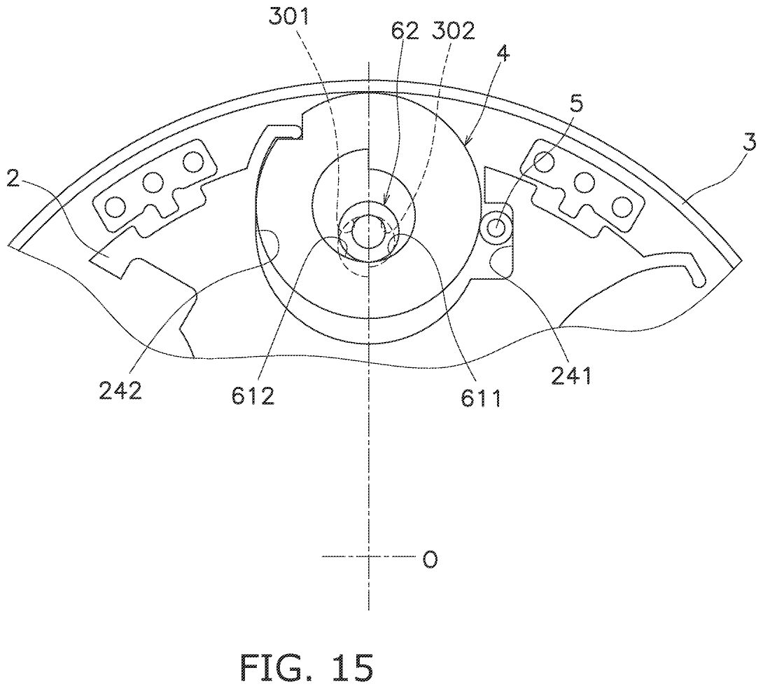

Next, the action of the torque fluctuation inhibiting device 10 will be explained. First, as shown in FIG. 15, when the hub flange 2 and the inertia ring 3 are not in rotation relative to each other, i.e., when the rotational phase difference θ is zero, each centrifugal element 4 is in the neutral state. Because of this, each cam follower 62 makes contact with the boundary between the first and second regions 611 and 612. Besides, each cam follower 62 makes contact with the boundary between the third and fourth regions 301 and 302. Each centrifugal element 4 is not in rotation about the rotational axis thereof.

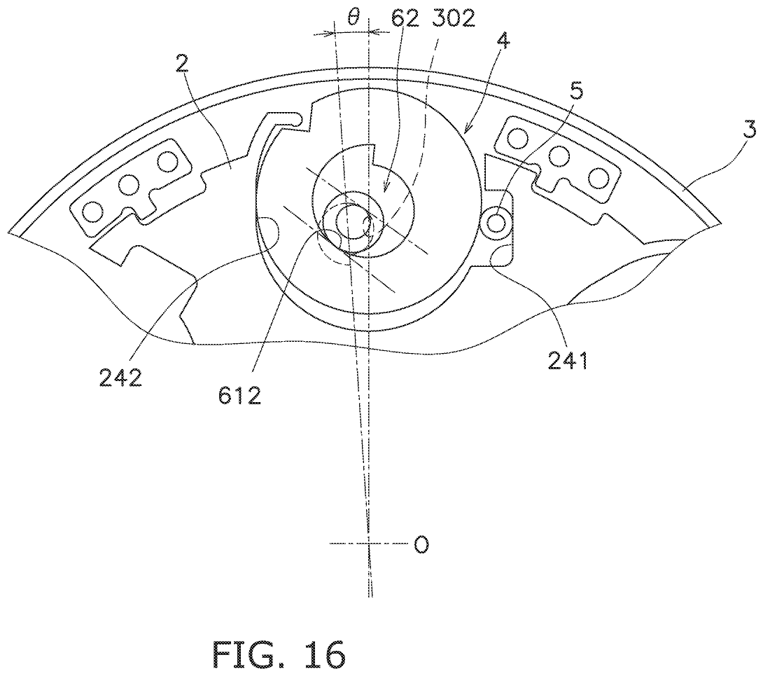

As shown in FIG. 16, when the inertia ring 3 is rotated counterclockwise relative to the hub flange 2, each centrifugal element 4 rolls on the second guide surface 242. It should be noted that each centrifugal element 4 rolls clockwise.

Each cam follower 62 rolls on the cam surface 61, specifically, on the second region 612. Besides, each cam follower 62 rolls on the contact surface 30, specifically, on the fourth region 302. Thus, each cam follower 62 is sandwiched between the second and fourth regions 612 and 302. It should be noted that each cam follower 62 rolls counterclockwise.

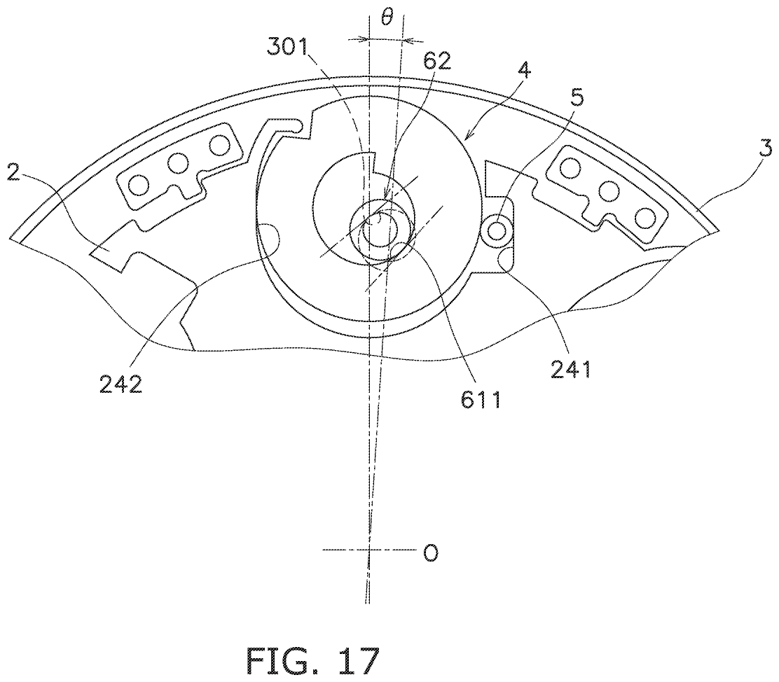

As shown in FIG. 17, when the inertia ring 3 is rotated clockwise relative to the hub flange 2, each centrifugal element 4 rolls on the first guide surface 241 through each first rolling member 5. It should be noted that each centrifugal element 4 rolls clockwise.

Each cam follower 62 rolls on the cam surface 61, specifically, on the first region 611. Besides, each cam follower 62 rolls on the contact surface 30, specifically, on the third region 301. Thus, each cam follower 62 is sandwiched between the first and third regions 611 and 301. It should be noted that each cam follower 62 rolls clockwise.

Each centrifugal element 4 herein rolls not directly on the first guide surface 241 but on the first guide surface 241 through each first rolling member 5. Because of this, when the first region 611 is set to be equal in curvature radius to the second region 612, it is concerned that an angle formed between a first tangent and a second tangent undesirably deviates from an appropriate angular range. As a result, occurrence of the following drawback is concerned: Each cam follower 62 cannot be firmly sandwiched between the contact surface 30 and the cam surface 61. It should be noted that the term “first tangent” means an imaginary tangent drawn at a contact point between each cam follower 62 and the cam surface 61, whereas the term “second tangent” means an imaginary tangent drawn at a contact point between each cam follower 62 and the contact surface 30.

By contrast to the setting, in the present modification, the first region 611 is different in curvature radius from the second region 612; specifically, the first region 611 is set to be less in curvature radius than the second region 612. Hence, the angle formed between the first tangent and the second tangent falls within the appropriate angular range, whereby each cam follower 62 can be firmly sandwiched between the cam surface 61 and the contact surface 30.

Moreover, in the present modification, the third region 301 is different in curvature radius from the fourth region 302; specifically, the third region 301 is set to be greater in curvature radius than the fourth region 302. Hence, the angle formed between the first tangent and the second tangent falls within the appropriate angular range, whereby each cam follower 62 can be firmly sandwiched between the cam surface 61 and the contact surface 30.

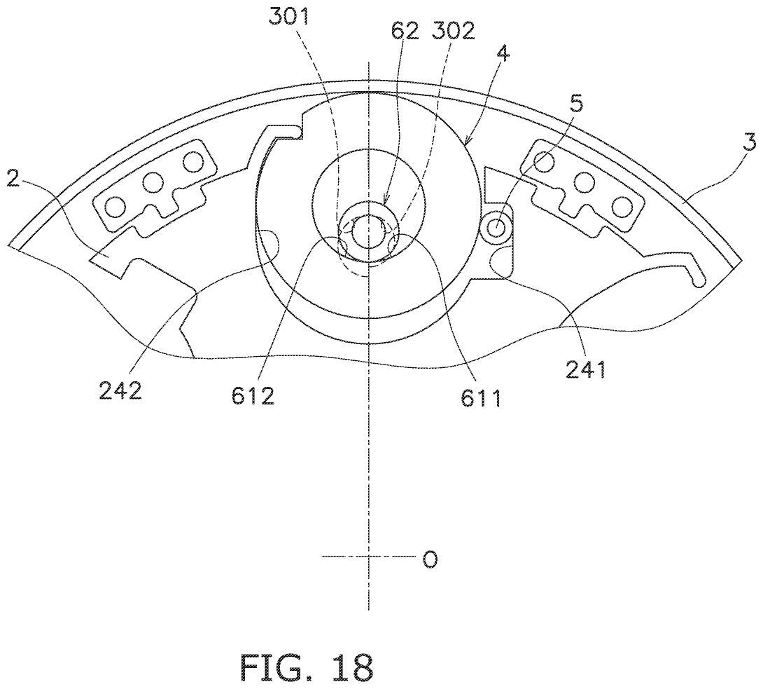

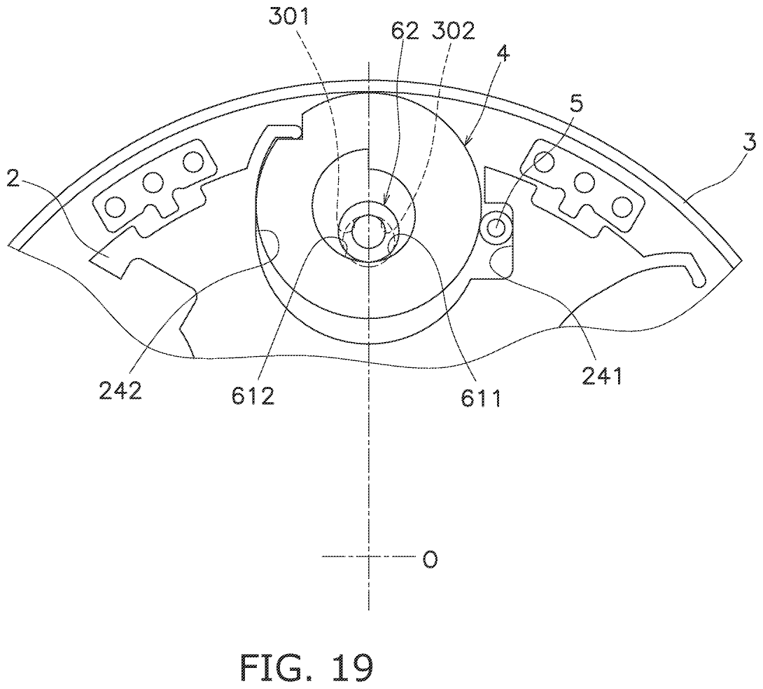

It should be noted that as shown in FIG. 18, the third and fourth regions 301 and 302 can be different in curved surface shape from each other, whereas the first and second regions 611 and 612 can be identical in curved surface shape to each other. Alternatively, as shown in FIG. 19, the first and second regions 611 and 612 can be different in curved surface shape from each other, whereas the third and fourth regions 301 and 302 can be identical in curved surface shape to each other.

### <Modification 6>

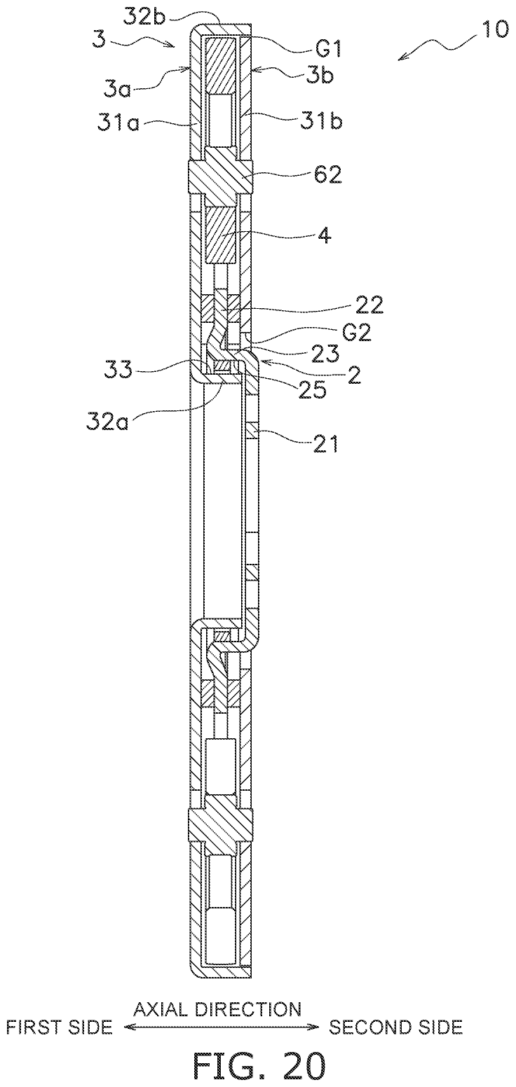

In the preferred embodiment described above, the second plate 3b includes the second cylindrical portion 32b. However, the configuration of the inertia ring 3 is not limited to this. For example, as shown in FIG. 20, the first plate 3a can include the second cylindrical portion 32b. In this case, the first plate 3a includes the first annular portion 31a, the first cylindrical portion 32a, and the second cylindrical portion 32b. The first cylindrical portion 32a axially extends from the inner peripheral end of the first annular portion 31a toward the second plate 3b. The second cylindrical portion 32b axially extends from the outer peripheral end of the first annular portion 31a toward the second plate 31b.

It should be noted that the first gap G1 is produced between the distal end of the second cylindrical portion 32b and the outer peripheral end of the second annular portion 31b. In other words, the outer peripheral surface of the second annular portion 31b is disposed apart from the inner peripheral surface of the second cylindrical portion 32b at an interval, while not in contact therewith. The first gap G1 can be provided over the entire range in the circumferential direction, or alternatively, can be provided only in part of the entire range in the circumferential direction. It should be noted that the outer peripheral surface of the second annular portion 31b can make contact with the inner peripheral surface of the second cylindrical portion 32b so as not to produce the first gap G1 therebetween.

In the present modification, the second plate 3b includes only the second annular portion 31b without including the second cylindrical portion 32b.

### REFERENCE SIGNS LIST

2: Hub flange
21: Inner peripheral portion
22: Outer peripheral portion
23: Connecting portion
24: Accommodation portion
241: First guide surface
242: Second guide surface
25: First support surface
3: Inertia ring
3a: First plate
31a: First annular portion
32a: First cylindrical portion
3b: Second plate
31b: Second annular portion
32b: Second cylindrical portion
33: Second support surface
36: Second through hole
4: Centrifugal element
41: First through hole
5: First rolling member
6: Cam mechanism
61: Cam surface
62: Cam follower
10: Torque fluctuation inhibiting device
15: Slide member
16: Spacer
100: Torque converter
141: Input member
142: Output member
G1: First gap
G2: Second gap

What is claimed is:

1. A rotary device comprising:
a first rotor disposed to be rotatable; and
a second rotor disposed to be rotatable with the first rotor and be rotatable relative to the first rotor, the second rotor including a first plate and a second plate, the first plate and second plate being configured to form an accommodation space accommodating an outer peripheral portion of the first rotor.

2. The rotary device according to claim 1, wherein
the first plate includes a first annular portion and a first cylindrical portion, the first cylindrical portion axially extending from an inner peripheral end of the first annular portion toward the second plate, and
the second plate includes a second annular portion and a second cylindrical portion, the second annular portion disposed axially apart from the first annular portion, the second cylindrical portion axially extending from an outer peripheral end of the second annular portion toward the first plate.

3. The rotary device according to claim 2, wherein the first annular portion is disposed to produce a first gap between an outer peripheral end thereof and a distal end of the second cylindrical portion.

4. The rotary device according to claim 1, wherein
the first plate includes a first annular portion, a first cylindrical portion, and a second cylindrical portion, the first cylindrical portion axially extending from an inner peripheral end of the first annular portion toward the second plate, the second cylindrical portion axially extending from an outer peripheral end of the first annular portion toward the second plate, and
the second plate includes a second annular portion disposed axially apart from the first annular portion at an interval.

5. The rotary device according to claim 2, wherein the second annular portion is disposed to produce a second gap between an inner peripheral end thereof and a distal end of the first cylindrical portion.

6. The rotary device according to claim 5, wherein the first rotor includes an inner peripheral portion and a connecting portion, the inner peripheral portion disposed outside the accommodation space, the connecting portion extending through the second gap and connecting the outer peripheral portion and the inner peripheral portion.

7. The rotary device according to claim 6, wherein
the connecting portion includes a first support surface facing radially inward, and
the first cylindrical portion includes a second support surface radially facing the first support surface to be supported by the first support surface.

8. The rotary device according to claim 7, further comprising:
a slide member disposed between the first support surface and the second support surface.

9. The rotary device according to claim 8, wherein
the first rotor has a plate shape, the first rotor greater in thickness than the second rotor, and
the slide member is attached to the first support surface.

10. The rotary device according to claim 1, further comprising:
a spacer disposed axially between the first rotor and the second rotor.

11. The rotary device according to claim 1, further comprising:
a centrifugal element disposed to be radially movable, wherein
the first rotor includes an accommodation portion accommodating the centrifugal element.

12. The rotary device according to claim 11, wherein the centrifugal element is configured to rotate about a rotational axis thereof in radial movement thereof.

13. The rotary device according to claim 12, further comprising:
a first rolling member, wherein
the accommodation portion includes a first guide surface and a second guide surface, the first and second guide surfaces circumferentially facing each other, and
the first rolling member is disposed between the first guide surface and the centrifugal element, the first rolling member configured to roll on the first guide surface in accordance with rotation of the centrifugal element about the rotational axis thereof.

14. The rotary device according to claim 13, wherein the centrifugal element is configured to roll on the second guide surface.

15. The rotary device according to claim 13, wherein
each of the centrifugal element and the first rolling member has a hollow or solid cylinder shape, and
a distance between the first guide surface and the second guide surface is less than a sum of a diameter of the centrifugal element and a diameter of the first rolling member.

16. The rotary device according to claim 11, further comprising:
a cam mechanism configured to receive a centrifugal force acting on the centrifugal element, the cam mechanism configured to convert the centrifugal force into a circumferential force directed to reduce rotational phase difference between the first rotor and the second rotor.

17. The rotary device according to claim 16, wherein the cam mechanism includes
a cam surface provided on the centrifugal element, and
a cam follower making contact with the cam surface, the cam follower configure to transmit a force therethrough between the centrifugal element and the second rotor.

18. The rotary device according to claim 17, wherein the cam follower rolls on the cam surface.

19. The rotary device according to claim 17, wherein
the centrifugal element includes a first through hole axially extending therethrough, and
the cam surface is provided as part of an inner wall surface of the first through hole.

20. The rotary device according to claim 17, wherein the cam follower is attached to the second rotor in a state of being rotatable about a rotational axis thereof.

21. The rotary device according to claim 17, wherein
the second rotor includes a second through hole, and
the cam follower rolls on an inner wall surface of the second through hole.

22. The rotary device according to claim 17, wherein the cam follower is a roller having a solid or hollow cylinder shape.

23. A power transmission device comprising:
an input member;
an output member to which a torque is transmitted from the input member; and
the rotary device according to claim 1.
